(19) United States
(12) Patent Application Publication
(10) Pub. No.: US 2006/0177611 A1
(43) Pub. Date: Aug. 10, 2006

(54) Moulded plastic article having vibration damping properties and a method for preparation thereof

(76) Inventor: Percy Josefsson, Kolbygarde Prastgard (SE)

Correspondence Address: YOUNG & THOMPSON, 745 SOUTH 23RD STREET, 2ND FLOOR, ARLINGTON, VA, 22202, US

(21) Appl. No.: 11/327,306

(22) Filed: Jan. 9, 2006

Related U.S. Application Data
(60) Provisional application No. 60/642,514, filed on Jan. 11, 2005.

(51) Int. Cl. B31B 45/00

(52) U.S. Cl. 428/34.1; 428/457

(57) ABSTRACT

The present invention relates to a moulded plastic article provided with a vibration damping member, said member being formed from a vibration damping laminate comprised of a constrained viscoelastic layer (50) sandwiched between two rigid constraining metallic layers (40), which member is moulded into the article when moulding the article. The invention also relates to a method of preparing such plastic article by means of moulding.

### FIELD OF THE INVENTION

The present invention relates to a moulded plastic article provided with a vibration damping member, said member being formed from a constrained layer damping material, which member is moulded into the article during the moulding of the article. The invention also relates to a method of preparing such plastic article by means of moulding.

### BACKGROUND ART

In the automotive industry, attempts are constantly being made to reduce the fuel consumption of commercial vehicles. Such attempts include the reduction of the weight of the vehicles. Accordingly, there is a tendency to produce automotive parts, such as engine parts, with thinner walls and/or in more light-weight materials. Consequently, there is also a tendency in the art to replace metal as a construction material with plastic in order to further reduce the weight. Parts having a reduced weight generally tend to vibrate, and as a result, the automotive industry is being faced with increasing problems of undesired vibrations and noise, mediated or generated by parts having reduced weight.

This is especially a problem in parts of the engine, the transmission, and the brake system. Vibration damping materials are presently used as so-called applied damping materials (ADM), which are applied onto specific areas of plastic and metal automotive parts by means of adhesive and/or mechanical means, in order to damp vibrations by absorbing and dissipating the vibration energy, thereby reducing the noise radiating from the vibrating part. Such damping materials generally have the form of a laminate comprising a constrained layer of a viscoelastic material, such as rubber, and a constraining layer of a rigid material, such as steel, to which the viscoelastic material is intimately adhered. Such structure of the damping material is also referred to as “single constrained layer”. The applied damping materials may also comprise a second constraining layer.

There are, however, drawbacks of the prior art damping materials such as the risk of delamination and de-attachment of the applied damping material, and thus loss of the desired vibration damping action.

In the case of a moulded plastic article comprising a constrained layer damping material member, these drawbacks are overcome by the features of the characterising part of claim 1.

### SUMMARY OF THE INVENTION

According to the invention a vibration damping member formed from a constrained layer damping material is moulded into the plastic article during the moulding of the article, i.e. already at the stage of forming the plastic article by means of moulding, such as injection moulding.

The moulded plastic articles according to the invention are especially automotive parts, such as various panels and housings, for example oil pans, engine housings, chain drive housings, transmission covers, valve or cam covers, and inlet manifolds. Of course, other plastic articles or parts will suggest themselves to the skilled reader after having read this description.

Generally, the specific type of moulding used for forming such articles is injection moulding.

The damping member(s) can be located at any desired position(s) within the plastic article. The desired position(s) can easily be determined by the person skilled in the art using testing methods conventionally used in the ADM art.

The method of the present invention will also facilitate the production of a moulded plastic article provided with a vibration damping member.

The invention will be more fully understood with reference to the detailed description and drawings provided in the following.

### BRIEF DESCRIPTION OF THE DRAWINGS

FIG. 1 shows a valve cover 10 comprising a plastic article 20 into which a constrained layer vibration damping member 30 is moulded.

FIG. 2 shows an alternative embodiment of the valve cover 10 of FIG. 1, wherein a portion of the constrained layer vibration damping member 30 remains not covered by the plastic material.

FIG. 3 shows a further alternative embodiment of the valve cover 10 of FIG. 1, wherein the constrained layer vibration damping member is provided with holes 35, occupied by the plastic material of the moulded article.

### DETAILED DESCRIPTION OF THE INVENTION

By means of the method of the present invention, the process of preparing a moulded plastic article comprising a constrained layer damping material member, can be considerably facilitated in that the damping member is integrated into the plastic article simultaneously with the moulding thereof.

The inventive method generally comprises the following step: providing the vibration damping member in a cavity of a mould, which cavity is shaped to conform with the shape of the article to be produced, introducing a mouldable plastic material into the cavity, and, demoulding the moulded plastic article after settling of the plastic material.

Also, in of the present method, the laminate member is brought into a more intimate contact with the plastic material than in the prior art ADM methods, since the molten plastic will conform to the surface and any surface roughness of the laminate member during the moulding, thereby increasing the effective contact surface area as compared to the prior art ADM technique.

While no limitation to any specific theory is intended, it is believed that the damping effect of a given laminate member is dependent upon the effective contact surface area and thus, that an improved contact of the laminate with the plastic will improve the damping effect of the laminate member as compared to that of a similar laminate member used in the prior art ADM technique.

In order for effective vibration damping to be accomplished by means of the laminate member used in the invention, the viscoelastic layer should be constrained by two constraining layers, one of which could be formed by the surrounding plastic material of the article. The present inventors have found proper constraining function hard to be accomplished by means of the plastic material of the moulded article. Accordingly, the vibration damping member used in the invention therefore in itself comprises two rigid constraining layers. This also allows for a conventional method of moulding to be used for preparing the article.

The vibration damping member to be moulded into the article of the invention is therefore formed from a laminate including a constrained viscoelastic layer sandwiched between two rigid constraining layers.

The moulded plastic articles according to the invention are especially automotive parts, such as various panels and housings, for example oil pans, engine housings, chain drive housings, transmission covers, valve or cam covers, and inlet manifolds. Generally, the specific type of moulding used for forming such articles will be injection moulding.

The plastic material is not critical and can be selected from those conventionally used for the specific application. Such materials can be selected from any mouldable thermoplastic material conventionally used in the art, such polyamide (PA), polyetylene (PE), polypropylene (PP), polyphenylene-sulphide (PPS), or acrylonitrile-butadiene-styrene (ABS) plastic.

Any laminate constrained layer damping (CLD) material known in the art comprising a constrained vibration damping layer sandwiched between two constraining metal layers can be used in practising the invention. Such materials and the preparation thereof have been described in e.g. WO 93/13329, WO 96/30205 and WO 03/022568. Specific examples of suitable noise damping laminates are those sold by the company Trelleborg Rubore AB, Trelleborg, Sweden, under the designations Duru-Lam, Visco-Lam and ADM.

Such materials are presently used in the automotive industry as noise damping shims and insulators, such as for example in the braking system of commercial vehicles, and also as applied damping materials.

Examples of other vibration damping laminate products which can be used as the laminate member are those sold under the designation Antiphon by Antiphon, Quite Steel by MSC/Arcelor, and Bondal by Thyssen Krupp.

The viscoelastic constrained layer is typically formed from a rubber material, such as butyl rubber, NBR, SBR or EPDM, or an adhesive, such as acrylics, silicone or phenolic adhesives. Preferably, a rubber material is used, and especielly NBR. The thickness of the constrained viscoelastic layer is preferably within the range of 50 μm to 1 mm, such as about 100 μm.

The metal layers of the laminate will typically be made from aluminium, stainless steel, or steel, such as cold rolled sheet steel. In a case where rust protection is desired the laminate may be made from galvanized steel. Any conventional surface protection may be used, such as galvanized steel or aluminized steel.

The thickness of the constraining rigid metallic layer is not critical and is selected dependent upon the desired application. Preferably, the thickness is within the range of 0.2-1 mm, such as 0.5 mm.

When used in the present invention, the damping material from which the vibration damping member is formed can generally be referred to as integrated damping material (IDM). Accordingly, a conventional ADM material, when used in the present invention, is referred to as an IDM material.

In a preferred embodiment the outer surface of the vibration damping member is a polymeric layer, such as an elastomeric layer or rubber layer. Thereby a more efficient damping can be obtained. Preferably both outer surfaces are polymeric layers.

As will be realized by the person skilled in the art the damping material member can comprise further constrained viscoelastic layers and rigid constraining layers.

In the embodiments shown in the drawings, a vibration damping laminate product, ADM 512442, provided by Trelleborg Rubore AB, Sweden, has been used, corresponding to reference numeral 30. The laminate comprises a total of four layers of alternating metal layers 40 and polymeric layers 50. The polymeric layers 50 are formed from NBR rubber and the metal layers 40 are formed from galvanized steel.

The suitable geometrical shape of the damping material member to be moulded into the specific article, as well as the proper position of the laminate member can be determined by means of methods conventionally used in the art of the ADM technique. Such methods can, for example, on measuring the amplitude of the vibrations of different areas of the specific plastic article while subjecting the article to vibrations of a certain frequency. The amplitude is then compared to measurements on the article provided with a damping material member, attached to a certain portion of the surface thereof. Once a suitable surface position and a suitable geometrical shape of the damping material member have been established, the position, i.e. the depth, of the damping material member in the moulded plastic article is not considered to be critical and can be selected based on practical and design considerations.

By embedding the laminate member in the plastic material a larger surface area of said member will be brought into contact with the plastic material than in the prior art ADM methods. It is believed that an increased contact surface area will improve the damping efficiency of the laminate member.

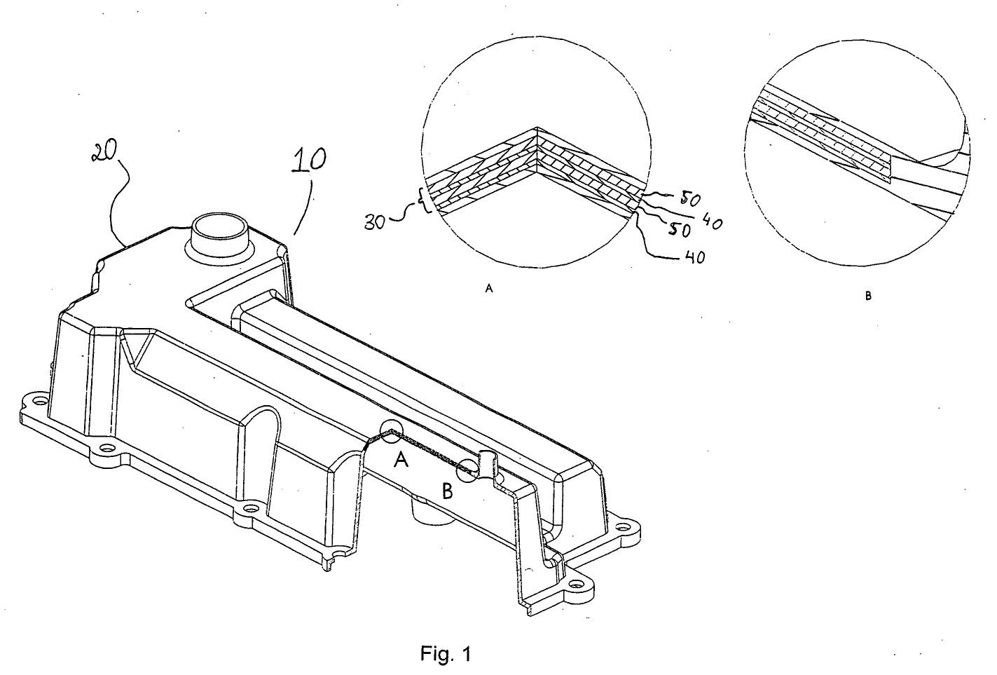

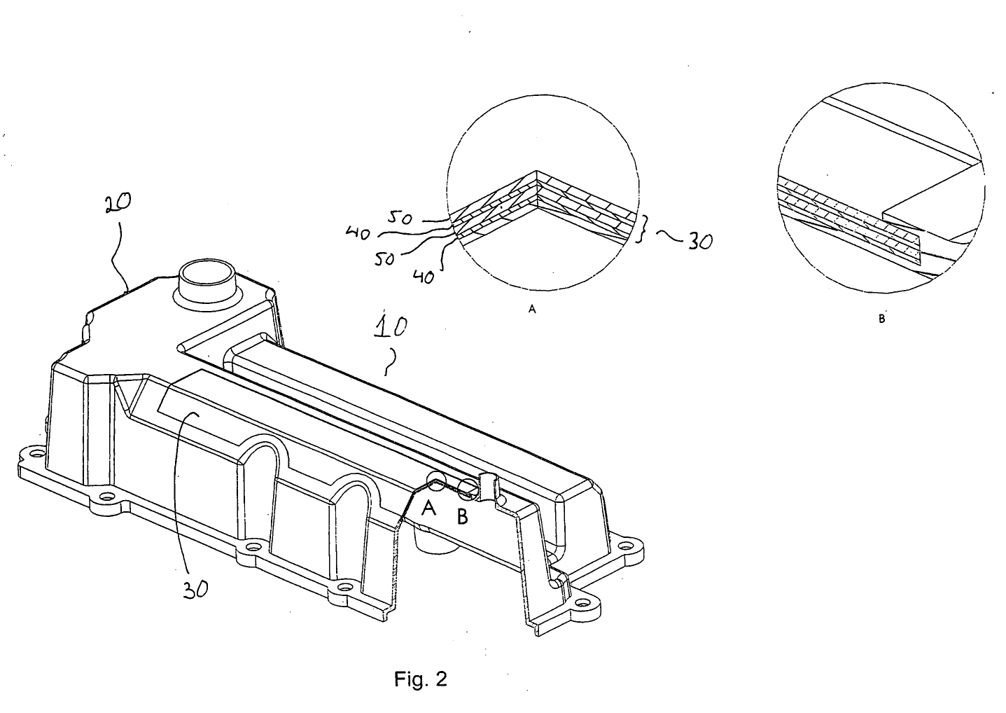

While, for the purpose of minimising the risk of delamination and de-attachment of the damping material member, it is preferred that the member be embedded in the plastic material of the article, such as shown in FIG. 1, it is also possible to leave a portion of a surface thereof not covered by the plastic material such as shown in FIG. 2. As will be obvious to the person skilled in the art such non-covered surfaces can be provided with visible information, or may in itself form visible information or other aesthetic features. When a portion of a surface of the damping material member is not covered, it is preferred that the edges, or the circumferential area of said surface is embedded in the plastic material.

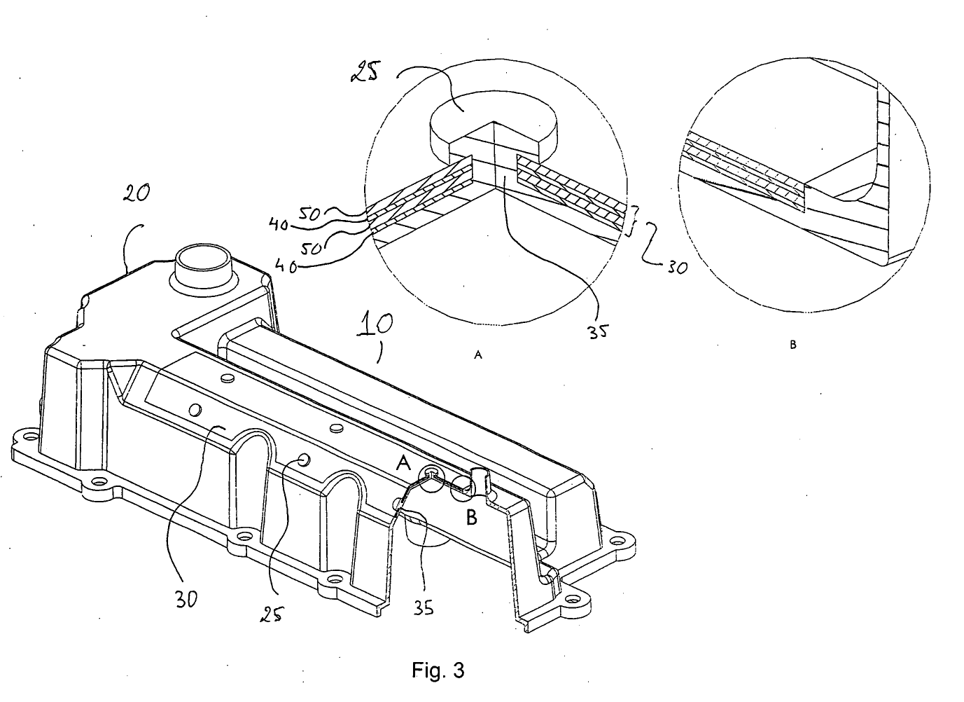

In order to increase the integrity, durability and strength of the moulded plastic article provided with the damping member of the invention, the laminate member could be provided with one or more holes essentially normal to the surface thereof, which holes will be filled by the plastic material, thus further securing the member in the desired position in the moulded article. Such an embodiment is shown in FIG. 3, wherein reference numeral 35 designates such hole. As will be obvious to the person skilled in the art, the portion(s) 25 may for example be shaped so as to form visible information, or other aesthetic features. The laminate member in the embodiment shown in FIGS. 1 and 2 can of course also be provided with holes, such as for example shown in FIG. 3.

While the present invention is primarily directed to automotive plastic articles, it is also conceivable to apply the method of the invention in the production of other plastic articles also subjected to considerable vibrations during use, such as for example plastic panels in washing machines, dish washers, tumble dryers, refrigerators and other household appliances.

1. A moulded plastic article (20) provided with a laminated vibration damping member (30) including a constrained viscoelastic layer (50), characterised in that said constrained viscoelastic layer (50) is sandwiched between two rigid constraining metallic layers (40), and that the member is moulded into the article.

2. The moulded plastic article according to claim 1, characterised in that the member is provided with an outer layer of a polymeric material.

3. The moulded plastic article according to claim 1, characterised in that the article is an automotive part.

4. The moulded plastic article according to claim 1, characterised in that the article is a part selected from the group consisting of oil pans, engine housings, chain drive housings, transmission covers, valve or cam covers, and inlet manifolds.

5. Method of producing a moulded plastic article (20) provided with a laminated vibration damping member (30) comprising a constrained viscoelastic layer (50) sandwiched between two rigid constraining layers (40), characterised in the following steps:
providing the vibration damping member (30) in a cavity of a mould, the cavity being shaped to conform with the shape of the article to be produced,
introducing a mouldable plastic material into the cavity, and,
demoulding the moulded plastic article after settling of the plastic material.

6. Method of claim 5, characterised in that the method of producing the moulded article is injection moulding.

7. The moulded plastic article according to claim 2, characterised in that the article is an automotive part.
